(19) United States
(12) Patent Application Publication
(10) Pub. No.: US 2009/0049495 A1
(43) Pub. Date: Feb. 19, 2009

(54) METHOD AND APPARATUS FOR CREATING, MANAGING, SENDING AND TRACKING VIDEO PRESENTATIONS WITH EMAILS

(76) Inventors: Lori K. Ketterling, Overland Park, KS (US); Donovan D. Scott, II, Lawrence, KS (US)

Correspondence Address: D.A.N Chase;Chase Law Firm, L.C., 800 W. 47th Street, Suite 401, Kansas City, MO, 64112, US

(21) Appl. No.: 12/188,745

(22) Filed: Aug. 8, 2008

Related U.S. Application Data
(60) Provisional application No. 60/964,592, filed on Aug. 14, 2007.

(51) Int. Cl. H04N 7/173

(52) U.S. Cl. 725/112

(57) ABSTRACT

The invention includes improvements in the method and apparatus for enabling a video presentation, that is located at a remote location from the email, such a special video server, to be begin playing almost immediately when that email is opened.

### CROSS REFERENCE TO RELATED APPLICATION

This application claims the benefit of previously filed provisional application Ser. No. 60/964,592, filed Aug. 14, 2007, entitled A METHOD AND APPARATUS FOR CREATING, MANAGING, SENDING AND TRACKING VIDEO PRESENTATIONS WITH EMAILS.

### FIELD OF THE INVENTION

This invention relates to a method and apparatus for providing video presentations on-line without the requirements of attaching a separate video file to an email message.

### BACKGROUND OF THE INVENTION

The desirability of having the ability to instantly display a video message in front of a potential or existing customer or as part of a professional relationship provides an opportunity to inform as never before. While the ability to add and send a video file to an email was a giant step forward in internet technology only a few years ago, the invention now enables a person, company or other professional organization to contact a desired person, whether known or not known to that person, and immediately display of their video presentation. The ability to contact and instantly promote a prepared and targeted message to a selected audience is unprecedented in marketing to date.

### SUMMARY

The present invention may be used to send an email that when opened will immediately initiate the playing of a video message without actually attaching a video file to the email. An email can be formatted to initiate the playing a video message when opened, that is small and in a standard email HTML format so that it can pass through firewalls and other security systems without being blocked.

A user may create an account that they can manage, upload, modify, track, keep records of use and accounting and activate the system for use when desired.

The present invention can be configured to provide public access to the system through on site Kiosks in malls and stores and like settings for people of no ordinary skill to take video of themselves and then produce a presentation for their use such as birthday and holiday video greetings to family and friends.

### BRIEF DESCRIPTION OF DRAWINGS

FIG. 1 is a general flow diagram of a process of designing and creating a presentation.

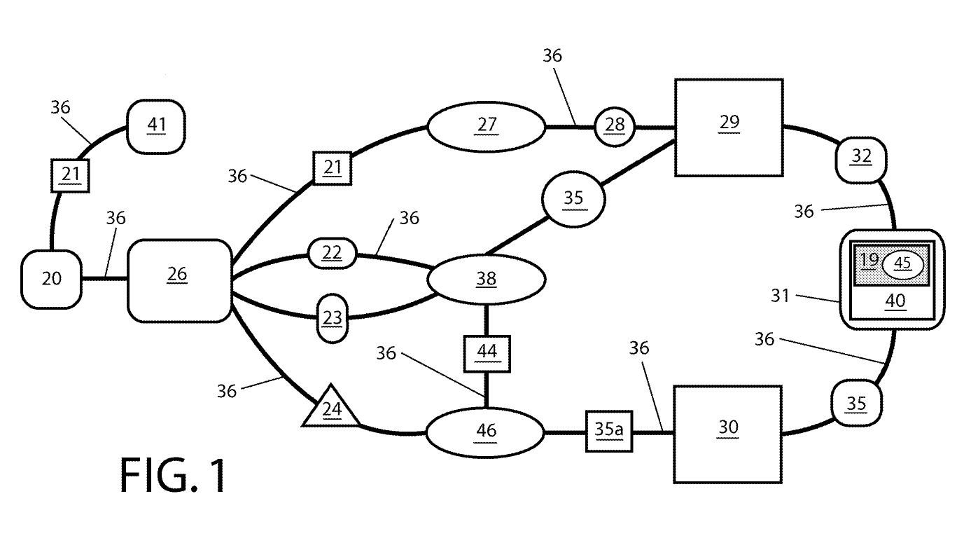

FIG. 2 is a general flow diagram of the sender using the presentation software of the present invention to create and manage their presentation.

FIG. 3 is an illustration of a Kiosk with the presentation system and video camera.

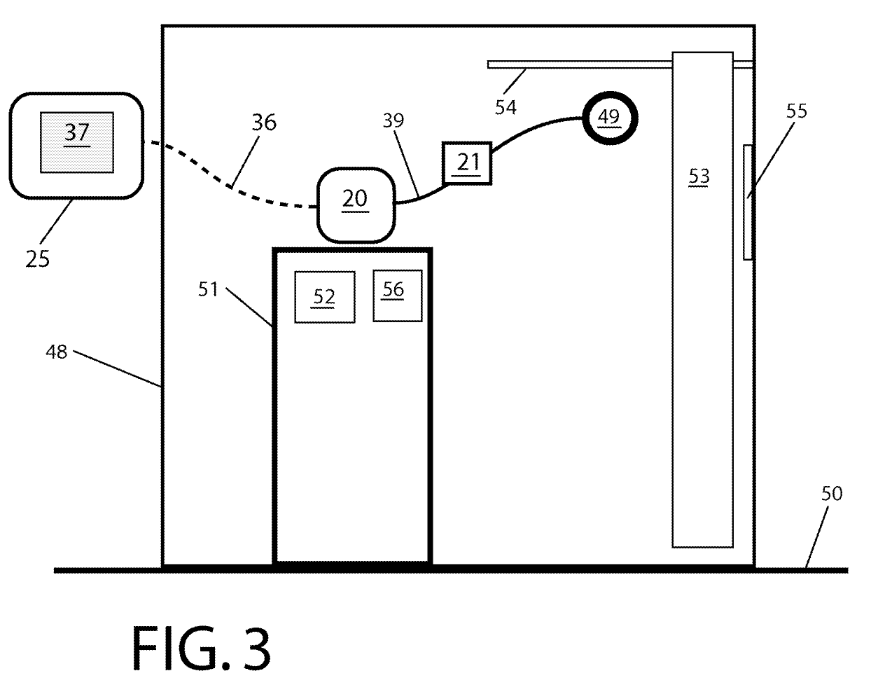

FIG. 4 is a schematic type drawing of the home page links of the presentation system web site.

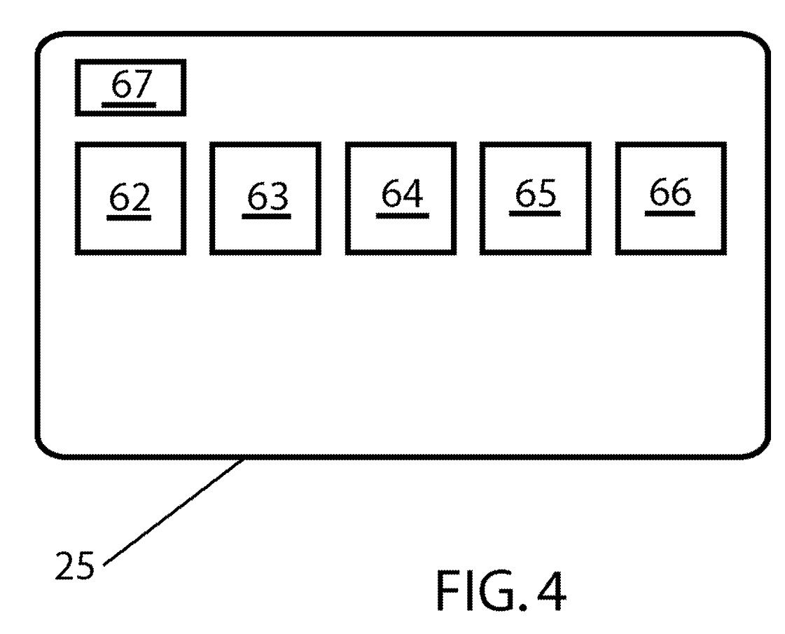

FIG. 5 is a schematic drawing of the login section and user account links on the home page of the presentation system web site.

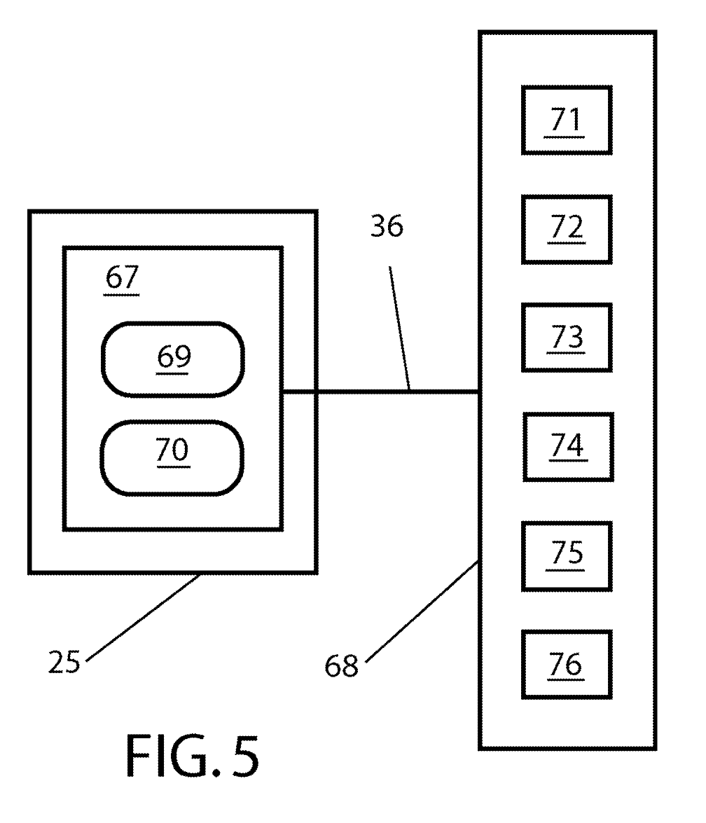

FIG. 6 is a schematic drawing of examples of various secondary links and functions relating to tools and reports that may be available on the presentation system web site.

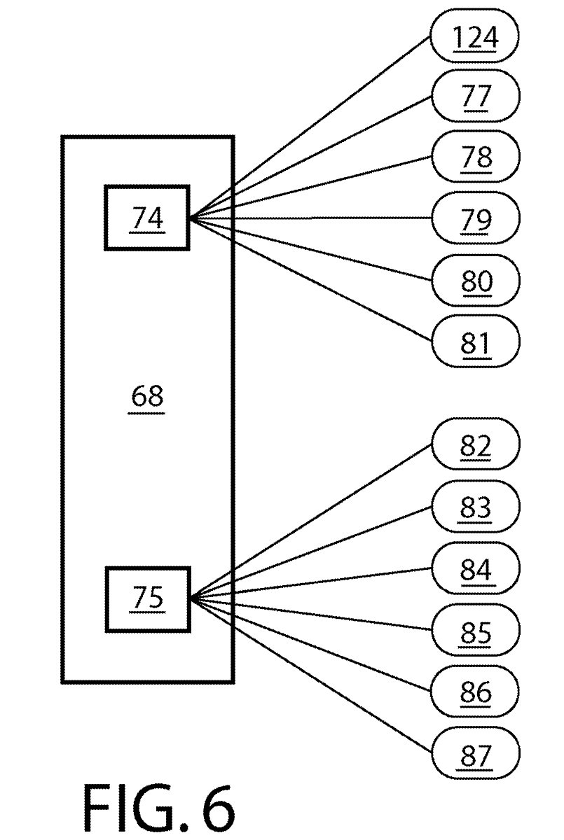

FIG. 7 is a schematic drawing of examples of various secondary links and functions relating to videos that may be available on the presentation system web site.

FIG. 8 is a schematic drawing of examples of various secondary links and functions relating to production that may be available on the presentation system web site.

### DETAILED DESCRIPTION

Referring to the figures, a general flow diagram showing a manual process for displaying video 21 on computer monitor 31 of email 40 to a targeted recipient is illustrated. Video 21 can be designed to play almost immediately when an email 40 is opened, which allows and enables the sender to make sure their message 45 is received and viewed. Typically, when a video is sent via the internet 36 as part of an email 40 to a known or unknown recipient, it is sent as an attachment to the email 40 in the form of a video file video file. Often times there may be some hesitancy on the recipient's part, especially if they are not familiar with the sender's email address 24, to open a video (as an attachment) for fear of a virus or because it may contain unsuitable material. When video 21 is sent by sender to function as a marketing tool to make an introduction of one's products and or services or information, it is preferable to have the video 21 and the message 45 contained within the email to begin playing immediately to the targeted email recipient.

The process begins with a videographer taking video 21 and in the configuration shown sending the video 21 as a movie file attachment to an email via the internet 36 to a user's computer 31. The video 21 may also be mailed or otherwise delivered to the user in an electronic format. Once the user has possession of video 21, he or she can then select a message layout template 22, content 23 (message body) and targeted email list 24 (all four items: message layout template 22, content 23, video 21 and email list 24 may be packaged as a single presentation unit 19). The user then sends the four items to a computer work station 26 where the information can be organized and prepared for further processing. For example, video 21 may be sent in an appropriate file or format to Flash® video converter 27 via internet 36. Streamable video converter 27 can then convert the video 21 to streamable video 28 and send it to Host server 29 via internet 36 where it can be stored for later use.

As part of the process and at approximately the same time, the matching message layout template 22 and content 23 can be sent to template and merging processor 38 via internet 36 or by another means, such as a computer terminal or cable connection. The message layout template 22 and content 23 can be converted into an HTML email format 44 to mass email mailer 46 which in turn can prepare the information before it is sent to SMTP server 30. The prepared information may then be stored and be accessible in a HTML standard format 35 by Host server 29 via internet 36.

A SMTP server 30 can then send email 40 to the computers 31 of the targeted recipients. Email(s) 40 are generally sent via internet 36 to the inbox of the recipients email client such as Outlook, Yahoo Mail, Gmail, Hotmail, etc. Computer 31 may be any form of a computing and display device such as a laptop computer, desktop computer, cell phone, PDA device, IPhone and other similar devices. Email 40 does not contain the sender's message 45 in the form of a video file which would require downloading, but instead enables message 45 to be sent from Host server 29 as streamable video stream to be immediately displayed on recipient's computer 31.

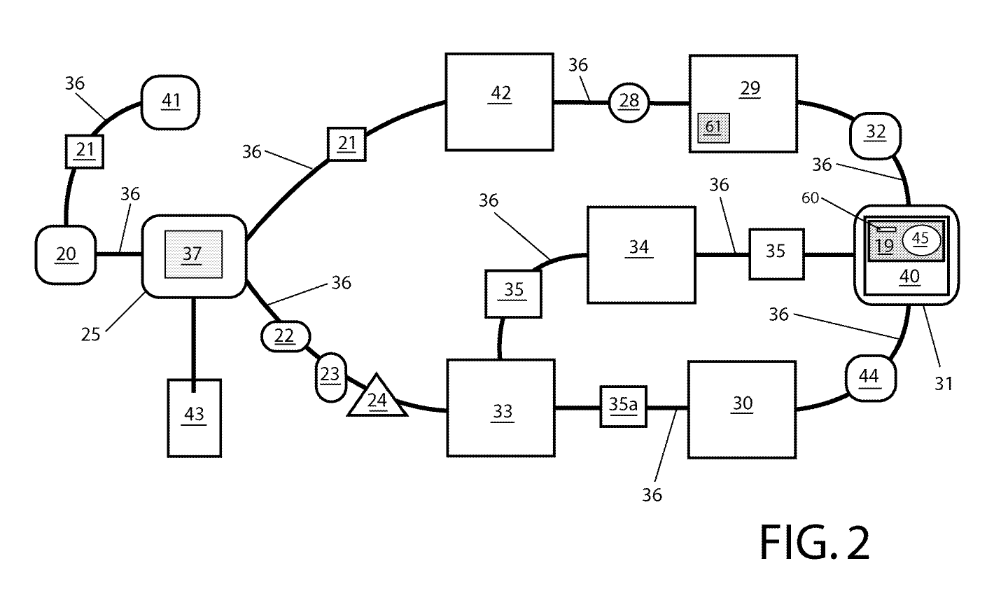

FIG. 2 is a flow diagram of generally a more efficient and user friendly method of creating, managing, tracking and sending email(s) 40 with streamable video stream 32 used as the format to convey message 45 to targeted recipients. For example, one purpose of a sender sending presentation unit 19 to targeted recipients is to gain their immediate attention with their message 45. To keep email 40 small and able to pass the various filter elements on a computer monitor 31 of known and unknown recipients, streamable video 28 remains on video server 29 until it is accessed. Streamable video stream 32 begins flowing to computer monitor 31 with the simple clicking action of the recipient when opening the matching email 40. In this configuration, video 21 can be supplied to sender to begin the presentation process.

Video 21 may be supplied by a professional videographer, friend, associate or by the sender or even from a presentation Kiosk booth 48 so long as it is suitable for uploading and conversion to the streamable video stream 32 or other suitable format. Sender or sender's agent accesses and uses presentation software program 37 and first uploads video 21 to begin the process. Sender or sender's agent may also access presentation web site 25 to gain access to presentation software program 37. Second, sender selects the desired message layout template 22 from the styles available and third, adds the text to the content message body 23.

The fourth step requires the sender to add the list of email addresses 21 of the recipients as targeted by the sender. As shown, the sender may wish to upload all or part of the email address index 43 to the presentation software program 37 from their existing email account. The presentation unit 19 is typically used for business or professional types of marketing applications to convey their message 45 using video 21 form as opposed to sending a friend a video file as an attachment as part of email correspondence.

Once all of the data (video 21, message layout template 22, content of message body 23 and email address index 43) for presentation unit 19 is entered into presentation software program 37, then sender approves all and produces presentation unit 19 as follows. Video 21 is sent to video converter server 42 via internet 36 whereby video converter server 42 converts video 21 to streamable video 28. As this process is completed, streamable video 28 is transferred to video server 29 where it is stored and will play from.

In a similar manner and at approximately the same time, presentation software program 37 will send message layout template 22, content of message body 23 and email address index to application server 33 via internet 36 or other types of computer connection that may be wired or wireless in design. Application server 33 then sorts this data and sends the message layout template 22 and content of message body 23 as HTML standard format 35 information to web server 34 while email address index 43 is sent to SMTP server 30 in HTML email format 44 information via internet 36 or by other suitable means such as a wired or wireless connection.

HTML standard format 35 and HTML email format 44, as parts of message 45 to form presentation unit 19, are sent from web server 34 and SMTP server 30 respectively, to a target recipient(s) inbox of their email client such as Yahoo Mail, Gmail, etc. As soon as recipient opens the sender's targeted email (which is purposely made into a small and non-threatening file that is generally able to penetrate the filters, firewalls and other security programs on a computer connected to internet 36) the streamable video stream, as part of message 45 of presentation unit 19, is accessed from Host server 29 immediately. Should presentation unit 19 be blocked and not begin playing immediately, recipient is instructed (from content of message body 23 of presentation unit 19) to click icon 60 on computer screen to play message 45 of presentation unit 19.

A Kiosk 48 can be located on floor 50 in a mall or store type setting where people can create their own video 21 as well as continue on to produce an presentation unit 19. Included at part of Kiosk 48 is video camera 49 (which can be fixed or adjustable), curtain support 54 and curtain 53. Curtain 53 may used a backdrop as well as “green background” should the user wish to add an artificial background scene available as part of the presentation software program to enhance heir video 21. Video camera 49 is connected to computer station 20 via cable 39. To start the video camera, user selects the various options available and makes a payment using payment station 52 that may accept credit cards, debit cards, gift cards and or cash.

To begin producing a presentation unit 19, user accesses presentation web site 25 via computer station 20 begin uploading video as part of their message 45. User continues to use presentation web site 25 and presentation software program and uses computer station 20 to establish a user account 57 with presentation software program 37. User continues with the production process by selecting a style of message layout template 22 and content of body message 23. User may also have video converted to a CD for pick up at CD module 56.

Links About Us 62, Services 63, Analysis 64, Hall of Fame 65, Contact Us 66 and Sign on 67 may be part of the home page presentation web site 25. Links About Us 62, Services 63, Analysis 64 and Hall of Fame 65 may be for general viewing purposes to learn about the presentation unit technology, products and services and not necessarily interactive with the user. Link Contact Us 66 is interactive with the user in that the user can use an email client to contact customer service. Link Sign On 67 is also interactive in that a new user can use this link to sign up as a customer and receive a username 69 and password 70 as well as to access the site, as needed to create, manage, update, schedule, track and modify their presentation unit(s) 19 on a continuing basis. It is in the spirit of the presentation web site and application program that further improvements and modifications will be made to the presentation unit technology.

A login procedure of a customer accessing customer links About You 71, Video 72, Produce 73, Tools 74, Reports 75 and Help 76 via internet 36 may be accessed by entering username 69 and password 70 on the Sign In link 67 on the home page of presentation web site 25.

A user account 68 portion of presentation web site 25 that provides a customer access to and control of the Tools 74 and Reports 75 links may be included. Tools 74 link offers the customer the options of choosing optional links such as Send a presentation unit 77, User Profiles 78, Recipient Groups 79, Customers 80, Video Upload 81 and Auto Scheduler 124 that are used for creating, managing, tracking and sending presentation units to selected recipients. Reports link 75 provides the customer a history of events or certain activities of a particular presentation unit 19 with Progress-Presentation Units link 82, Progress-Messages link 83, Send Messages link 84, Prospect Search link 85, Administrator Message 86 and Stuck Message link 87.

Auto Scheduler link 14 may be provided to enable user to select the following options that include but are not limited to the time of day, date, frequency of one or more mailings, type of format such as presentation unit tracking 91 or remail 92. Should presentation unit tracking 91 indicate that the email has not been opened in a specified amount of time, a remail 92 can be scheduled for sending. Remail 92 is available in one or more formats, one of which is primarily text link while another is a graphic text link. All remail 92 is tracked together and separately with the presentation unit tracking 91.

It is through the presentation web site 25 that enables customers to access and use the presentation application program 37 to manage their library 61 of one or more presentation units 19 without the help of specialized technicians and consultants to capture video and upload it in streamable video stream 32, to produce, edit, modify, schedule, track, report on and generally manage all aspects of this efficient and direct marketing effort—the presentation unit 19 message 45. The presentation library can be dissected by multiple users and individual customers on each user account 68 so that the Account owner can manage individual use and billing.

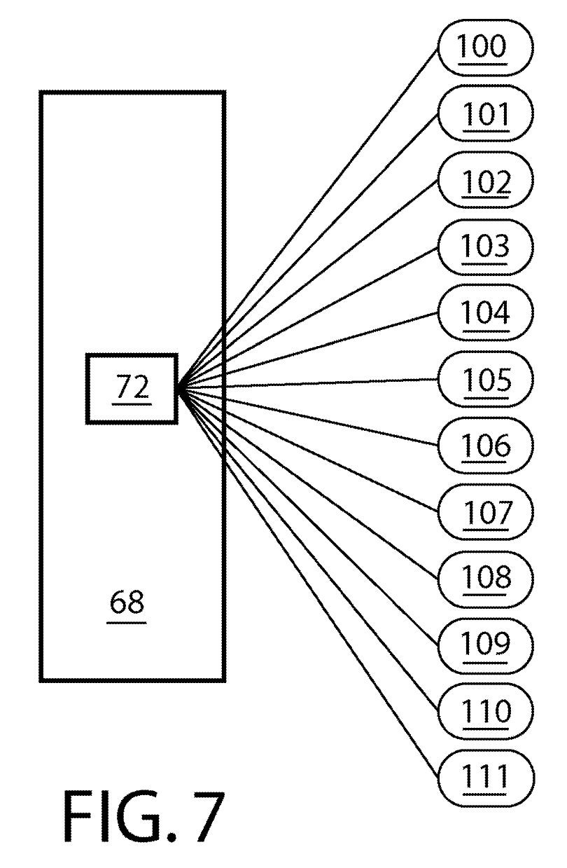

FIG. 7 is a schematic view of video link 72 on user account page 68 of presentation web site 25 that allows user to produce the video segment of message 45 of presentation unit 19. Presentation program 37 enables and provides user with Upload 100 link to place video 21 on or available to user's computer for storing and or editing. To edit raw video 21, user may use Edit Play 103 link that functions so as to allow user to opportunity to view video 21 on computer 31. Additional links Edit Clip Start 104, Edit Clip Stop 105, Edit Clip Save 106, Edit Clip Join 107 and Edit Clip Save 108 all function to allow user to produce an edited and final presentation unit 19 from raw video 21. Once presentation unit 19 is completed and ready for use, it is stored in library 61 for later use.

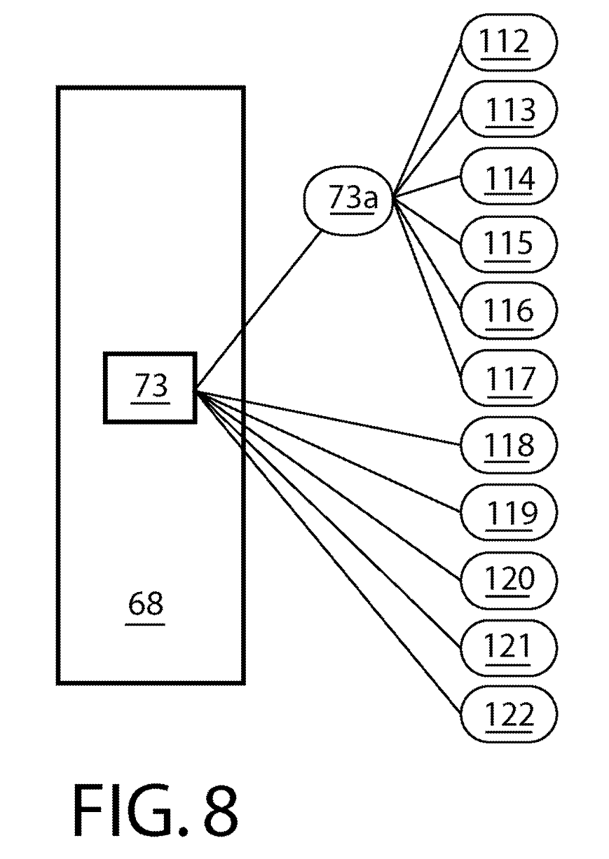

FIG. 8 is a schematic view of Production 73 link on user account 68 page that enables user to use Select Template 99 link that makes available six different styles including but no limited to Template A 112 link, Template B 113 link, Template C 114 link, Template D 115 link, Template E 116 link and Template F 117 link. Logo 93 and or other graphics may also be added to message layout template 22 during this process.

Once user selects one of these template links, it is saved and stored as the message layout template 22 segment of presentation unit 19. Next, user accesses Add Text 118 link to provide content message body 23 segment of presentation unit 19. Another step to be processed by presentation application program 37 is to convert and or assemble the Video Clip 123 segment, message layout template 22 segment and content message body 23 segment into presentation unit 19 and finally selecting the type of presentation unit 19 as either a s a presentation unit tracking 91 or as remail 92.

More specifically, content message body 23 is wrapped in a single element and all styles are nested beneath this element. This protects the message 45 from aggressive web clients, such as Yahoo Mail, which will strip the styles from message 45 while merging it into the web-mail page HTML. Also, in the a large portion of business email 40 environments, more sophisticated types of web client/browser applications such as Windows Outlook® or Thunderbird® do not rigorously strip emails and as a result provide a safe and efficient venue for a presentation unit tracking 91 to be used. Because sender's email 40 can be embedded with streamable video stream 32 with the presentation unit tracking 91, message 45 will begin playing almost immediately, without a further action on the part of recipient when the recipient opens the email 40.

When the presentation unit tracking 91 can't be used, typically because the email client of the recipient is bolstered with filters, a firewall and other security programs (stripping the email of an embedded video presentation or like information, remail 92 may be used. Remail 92 combines an image, resembling the type of imagery that simulates video player 95 and message layout template 22 as a presentation unit tracking 91. Remail 92 generally requires some action by the recipient to have it start playing. Remail 92 is designed so that when recipient clicks on icon 60 (i.e. click here to start) of message layout template graphic 22a, streamable video stream 32 will begin streaming from Host server 29 and subsequently appearing on computer 31.

Recipient may also be prompted to click icon 60a to download a program that converts and handles streamable video, such as Flash® by Adobe for viewing. Presentation units 19 that are sent out are encoded with a globally unique identifier GUID 97 which tags message 45 and email 40 various information, including a recipient's email address.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A method for presenting a video comprising:
capturing video,
storing said video on a video server,
creating an email including a link to the stored video on said video server,
sending said email to a recipient computer, and
displaying said video on said recipient computer upon opening said email.

2. The method as set forth in claim 1 further comprising converting said captured video to streamable video.

3. The method as set forth in claim 1 wherein said creating step includes selecting a message layout template.

4. The method as set forth in claim 1 wherein said creating step includes adding a message.

5. The method as set forth in claim 1 wherein said displaying step includes automatically displaying said video upon opening said email.

6. The method as set forth in claim 1 wherein said displaying step includes providing a link to select to display said video.

7. The method as set forth in claim 1 further comprising identifying brush strokes in said scanned image and associating a rhythm to each of said brush strokes.

8. The method as set forth in claim 1 further comprising identifying transitions in said scanned image and associating a tonal change to each of said transitions.

9. The method as set forth in claim 1 further comprising identifying texture variations in said scanned image and associating a rhythm or tone to each of said texture variations.

10. The method as set forth in claim 1 further comprising applying a plurality of filters to each of said scanned elements and combining sound elements for all filters for a scanned element.

11. The method as set forth in claim 1 further comprising assigning a volume level based on the brightness of a sound element.

12. The method as set forth in claim 1 further comprising assigning a related range of sounds to similar textures and/or colors.
